(19) United States
(12) Patent Application Publication
(10) Pub. No.: US 2024/0303290 A1
(43) Pub. Date: Sep. 12, 2024

(54) SYSTEMS AND METHODS FOR SCREENING NAMES FOR IDENTITY MATCHING

(71) Applicants: ABHISHEK GUPTA, Noida (IN); JIGAR SHAH, Noida (IN)

(72) Inventors: ABHISHEK GUPTA, Noida (IN); JIGAR SHAH, Noida (IN); RAVI SAROJ, Noida (IN)

(21) Appl. No.: 17/791,006

(22) PCT Filed: Feb. 4, 2022
(86) PCT No.: PCT/IN2022/050096

§ 371 Date: Jul. 6, 2022

(30) Foreign Application Priority Data
Jun. 14, 2021 (IN) 202111026465

(51) Int. Cl. G06F 16/9538; G06F 16/2458; G06N 20/20

(52) U.S. Cl. CPC G06F 16/9538; G06F 16/2468; G06N 20/20

(57) ABSTRACT

Disclosed herein are systems and methods for screening names for identity matching. The aforementioned systems are (i) a system (100) for screening and matching names, (ii) a system (300) for screening and matching names using high recall—high search filter is provided, (iii) a system (210) for training a model, (iv) a system 230 of parallel model trainer, (v) a method (400) that depicts working of the system (100), (vi) a method 404 that depicts working of pre-processing an input data.

### FIELD OF INVENTION

The present disclosure relates to identity screening methods and systems, and more particularly to the systems and methods for screening identity by name matching.

### BACKGROUND

Electronic name screening started in the nineties for the purpose of identity matching to track or identify persons or organisations making a specific transaction. This was specifically introduced to identify persons or organisations against whom there were sanctions or bans or who appeared in some criminal wanted lists. As an example, the name screening is used to block transactions by drug traffickers. In the earlier days, only a few names were screened. Now, however, millions of names are screened worldwide all the time and against an increasingly complex backdrop. Every time an individual makes a simple transaction—such as booking a flight, opening a bank account or even just buying a cinema ticket—their identity is checked and accordingly mapped to any of the sanction lists.

In face of increasing terror activities, and thereby increasing sanctions or name of people or organisations who have been sanctioned, the name screening for identity matching requirements have vastly gone up. With increase in names and increase in number of online transactions, it requires quicker, efficient and fool proof methods and systems to be deployed with each transaction that performs a name screening for identity matching.

Several techniques of matching names have been reported in the literature on basis of several principles. Some commonplace and well-known methods have been described here. One of the methods known is termed as “Common Key Method” in which an assignee names a key or code based on their name pronunciation so that similar sounding names end up sharing same code e.g., Soundex. A variation of “Common Key Method” is a list method in which all possible spelling variations of each name or text is first generated and then matched with an input list or text. In “Edit Distance Method” of name matching, a small number of changes that it takes for going to one name from another name is computed whereas in “Statistical Similarity Method” a model is trained to identify similar numerous paired names and a similarity score is generated. In a complex yet high precision method “Word Embedding Method”, each word is denoted or signified as a numerical vector based on its semantic meaning and thus a similarity score between two or more words is calculated with respect to the other words in their vicinity. In the “hybrid method” one or the above methods are combined to arrive at a specific use case/utility for name matching or text matching. The hybrid method may also be termed as “ensemble methods”. Of late, machine learning systems and methods are being applied to optimize an ensemble method or system based on objection function of minimizing error rate.

The algorithms, through systems and methods, are country/language specific. However, some may be utilized on a language family covering similar languages.

However, despite the several name matching algorithms, through respective systems and methods, being in practice, it requires each of them to be ensembled with other to enable a universal utility or even a universal function. Moreover, given the increased complexity of name screening for identity matching in face of changing landscape, it is required that such matchings be performed according to local laws and their particular list. For example, a person may be sanctioned or be wanted in a certain jurisdiction; and is however, not a person worth tracing in another jurisdiction, then the identity matching systems/processes must take such limitations into considerations.

Accordingly, there remains a need to develop name matching methods and systems that provide advanced identity matching engines with increased speed, efficiency, and sensitivity.

### SUMMARY

In one aspect of the present disclosure, a hybrid ensemble-based system for screening and matching names is provided. The system includes a search engine system configured with a storage engine for searching individual and organizational names from a data repository, in that the search engine system characterized in that an individual name search engine and an organizational name search engine, and a data processing system coupled with the search engine system via the storage for training the models.

In some aspect of the present disclosure, the search engine system includes a rest controller engine that communicates with an integrating engine that is configured to obtain an input data from the user or the data repository.

In some aspect of the present disclosure, the integrating engine is configured with the individual name search engine and the organizational name search engine to merge the result generated from the individual name search engine and the organizational name search engine.

In some aspect of the present disclosure, the individual name search engine and the organizational name search engine communicates with the storage for accessing the fuzzy matcher of individual names and fuzzy matcher of organizational names respectively.

In some aspect of the present disclosure, the data processing system includes a model trainer system that communicates with a parallel model trainer system for executing the name matching of individual names and organizational names via hybrid approach.

In some aspect of the present disclosure, the parallel model trainer system communicates with an object relational engine and the data repository for mapping the classes to individual and organizational names in a table to create a watchlist.

In some aspect of the present disclosure, the object relational engine communicates with the data repository, in that the data repository further collects and stores the databases of individual and organization names.

In second aspect of the present disclosure, a system for training the model to observe amendments on names in the data repository is provided. The system includes a data read engine coupled with the data repository to read the names of individual and organization from the data repository, a pre-processing engine coupled with the data read engine to process the names with respect to the category of names, a match code generation engine coupled with the pre-processing engine to collect the codex, a TDM trainer engine coupled with the match code generation engine to train the TDM with the intermediate distribution frame (IDF) on the actual name and a TDM storage coupled with the TDM trainer engine to save and collect the TDM data acquired by the model trainer system.

In some aspect of the present disclosure, the TDM trainer engine applies the singular value the decomposition on each TDM to reduce the dimensions of an input data.

In third aspect of the present disclosure, a system of parallel model trainer to observe amendments on names in the data repository, the system includes an organizational name listener engine coupled with the object relational engine and the data repository to update organizational name TDMs, an individual name listener engine coupled with the object relational engine and the data repository to update the individual name TDMs, an analyzation engine coupled with the organizational name listener engine and the individual name listener engine to validate and process the individual and organizational names, and a memory coupled with the analyzation engine, in that the memory stores the names when the analyzation engine validates the name.

In some aspect of the present disclosure, the memory is further coupled with the storage to store TDMs.

In fourth aspect of the present disclosure, an ensemble meta-learner model system, the system includes an input engine for receiving an input data that includes individual and organizational names, a pre-processing engine configured with the input engine to standardize the input data, a high recall-high search filter configured with the pre-processing engine to perform a search analysis on the input data, a feature generation engine configured with the high recall-high search filter to transform and prepare the input data for training, a first model engine configured with the feature generation engine to provide first probability of matched names from the input data, a second model engine configured with the feature generation engine to provide second probability of matched names from the input data and an ensemble meta-learner model engine coupled the first model and the second model to provide final probability of matched names from the input data.

In some aspect of the present disclosure, the high recall-high search filter provides top 500 names from the input data.

In some aspect of the present disclosure, the feature generation engine generates the feature on the input data and passed through the trained model by the first model engine, the first model engine and the ensemble meta-learner model engine for scoring.

In some aspect of the present disclosure, the final probability of matched names from the input data is stored in the output engine.

In fifth aspect of the present disclosure, the method for screening and matching names is provided. The method includes
reading an input data via the data read engine, pre-processing the input data via pre-processing engine to create term document matrix (TDM), generating match codes via the match code generation engine, vectorizing and dimensionally reducing pre-processed input query against the varied TDMs, normalizing the input data, sorting partially and merging the input data, generating the feature for the input data, applying different models via model trainer system, sorting the input data, validating the input data and obtaining an output data.

In sixth aspect of the present disclosure the method for pre-processing an input data via pre-processing engine to create term document matrix (TDM) is provided. The method includes converting the input data to lower case, standardizing the titles and honorifics, organizing and correcting keyword spelling and standardizing the input data, removing special symbols, removing duplicate words and separating duplicate characters.

### BRIEF DESCRIPTION OF THE DRAWINGS

Other objects, features, and advantages of the embodiment will be apparent from the following description when read with reference to the accompanying drawings. In the drawings, wherein like reference numerals denote corresponding parts throughout the several views:

FIG. 1 illustrates a block diagram of a system for screening and matching names, according to an embodiment herein;

FIG. 2 illustrates a block diagram of a system for screening and matching names using high recall-high search filter, according to an embodiment herein;

FIG. 3 illustrates a block diagram of a system for training a model, according to an embodiment herein;

FIG. 4 illustrates a block diagram of a system of parallel model trainer, according to an embodiment herein;

FIG. 5 illustrates a flowchart of a method that depicts working of the system of FIG. 1, according to an embodiment herein; and

FIG. 6 illustrates a flowchart of a method that depicts working of pre-processing an input data of FIG. 5, according to an embodiment herein.

To facilitate understanding, like reference numerals have been used, where possible to designate like elements common to the figures.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for improved text matching and particularly name matching algorithms, the embodiment herein provides an improved system and method for matching text or names that includes a method step of obtaining low level features in a name together with high level features.

In an embodiment, the text to be matched is a name. In a further embodiment, the name to be matches is name of a person or organization. In still further embodiment, the name to be matched is name of a mobile app, domain, website, or any combination of words that identify a person or an organization.

The term ‘data’ and ‘input data’ refer to an individual name or/and organization name that is given by the user and are interchangeably used in the context.

### Definitions

1. “Tokenization” refers to a process of breaking the stream of characters into individual words.

2. “Ngram” is a contiguous sequence of n items from a given sample of text. Items can be word or characters.

3. “Phonetic algorithm” is an algorithm used for indexing of words by their pronunciation.

4. “Soundex” is type of phonetic algorithms that is developed to encode surnames for use in censuses. Soundex codes are four-character strings composed of a single letter followed by three numbers.

5. “Metaphone, Double Metaphone, and Metaphone 3” are suitable for use with most English words, not just names. Metaphone algorithms are the basis for many popular spell checkers.

6. “New York State Identification and Intelligence System (NYSIIS)” maps similar phonemes to the same letter. The result is a string that may be pronounced by the reader without decoding.

7. “Term Document Matrix (TDM)” refers a mathematical matrix that describes the frequency of terms that occur in a collection of documents. In a document term matrix, rows correspond to documents in the collection and columns correspond to terms. There are various schemes for determining the value that each entry in the matrix should take. Such schemes are binary, term frequency, (term frequency and inverse document frequency) tf-idf.

8. “Stopwords” refers a commonly used word (such as “the”, “a”, “an”, “in” prepositions) that a search engine is programmed.

9. “Dimension Reduction” or dimensionality reduction is the process of reducing the number of random variables under consideration by obtaining a set of principal variables.

10. “Dot Product” is the sum of the products of the corresponding entries of the two sequences of numbers.

11. “Ngram similarity score” is defined as, let word1 includes n1 ngrams, word2 includes n2 ngrams if there are n common grams, thereby score is (n/n1+n/n2)½*100.

12. “Partial Sorting” is returning a list of the k smallest (or k largest) elements in order from the list of n elements. Complexity is O (n log k) time. Whereas in general the best sorting algorithm takes O (n log n) time.

13. “Qratio” is used to find out the Levenshtein distance between two strings. Let, t is the distance and if t=0 then return 1 else (r/(t+r)) is the Qratio where r is total match character.

14. “token sort_ratio” tokenizes the input text sort the text lexicographically orders and then find the Qratio.

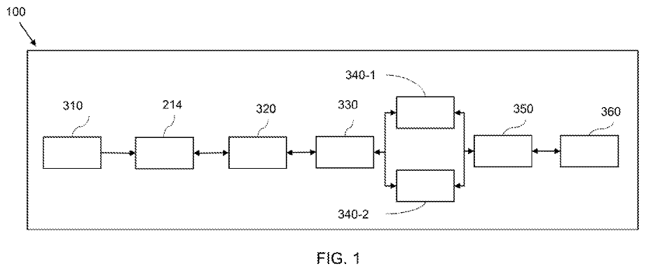

Referring to FIG. 1, a block diagram of a system 100 for screening and matching names in accordance with an exemplary aspect of the present disclosure.

The system 100 includes an input engine 310, a pre-processing engine 214, a high recall-high search filter 320, a feature generation engine 330, a first model engine 340-1, a second model engine 340-2, an ensemble meta-learner model engine 350, an output engine 360.

The input engine 310 communicates to the pre-processing engine 214. The pre-processing engine 214 is configured with the input engine 310. The high recall-high search filter 320 is configured with the pre-processing engine 214. The feature generation engine 330 is configure with the high recall-high search filter 320. The first model engine 340-1 and the second model engine 340-2 is configured with the feature generation engine 330. The ensemble meta-learner model engine 350 communicates with the first model engine 340-1 and the second model engine 340-2. The ensemble meta-learner model engine 350 is further coupled with the output engine 360.

The input engine 310 receives the input data that includes individual and organizational names. The pre-processing engine 214 is configured with the input engine 310 to standardize and modify the input data. The high recall-high search filter 320 performs search analysis on the input data. The feature generation engine 330 transforms and prepare the input data for training. The first model engine 340-1 and the second model engine 340-2 provides first and second probability of matched names from the input data respectively. The ensemble meta-learner model engine 350 provides the final probability of matched names from the input data.

In an embodiment, the high recall-high search filter 320 provides top 500 names. In an embodiment, the feature generation engine 330 generates the feature on the input data and passed through the trained model by the first model engine 340-1, the second model engine 340-2 and the ensemble meta-learner engine 350 for scoring. The final probability of matched names from the input data is stored in the output engine 360.

In an example, the system 100 may provide 10-20 percent (0.1-0.2 ratio) of probability of matching names when the names to be matched is ‘Rahul’ and ‘Tushar’. The system 100 may further provide the false positive rate of 15-20 percent. Whereas the system 100 may provide 90-100 percent (0.9-1.0 ratio) of probability of matching names when the names to be matched is ‘Tushar’ and ‘Tooshar’. The system 100 may further provide the false positive rate as 100 percent.

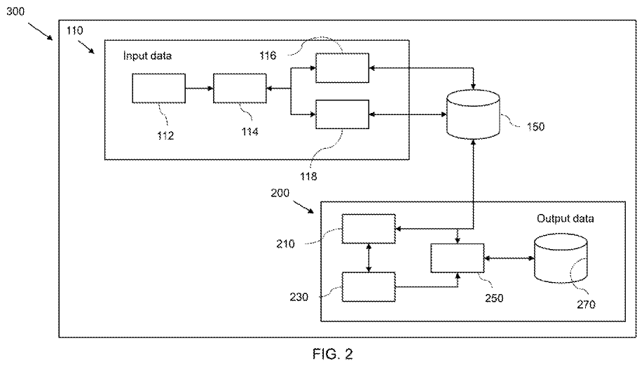

Referring to FIG. 2, a block diagram of a system 300 for screening and matching names using high recall-high search filter is provided, in accordance with an exemplary aspect of the present disclosure.

The system 300 for screening and matching names includes a search engine system 110. The search engine system 110 further includes a rest controller engine 112, an integrating engine 114, an individual name search engine 116 and an organizational name search engine 118. The system 300 further includes a storage 150 and a data processing system 200. The data processing system 200 further includes a model trainer system 210, a parallel model trainer system 230, an object relational engine 250 and a data repository 270.

The system 300 includes the search engine system 110. The search engine system 110 further includes the rest controller engine 112 that communicates with the integrating engine 114. The integrating engine 114 communicates with the individual name search engine 116 and the organizational name search engine 118. The individual name search engine 116 and the organizational name search engine 118 communicates with the storage 150. The system 100 further includes the data processing system 200 that includes the model trainer system 210 that communicates with the storage 150 and the parallel model trainer system 230. The parallel model trainer system 230 communicates with the object relational engine 250 and the data repository 270. The object relational engine 250 is further coupled with the storage 150.

The system 300 includes the search engine system 110. In an aspect, the search engine system 110 includes multiple name search techniques that includes, but not limited to ngram searching and phonetic ngram searching using term document matrix. The search engine system 110 includes the rest controller engine 112. In an embodiment, the rest controller engine 112 includes representational state transfer application programming interface (REST API) that conforms to the constraints of REST architectural style and allows for interaction with RESTful web services. In an aspect, the input is first given to the rest controller engine 112. The rest controller engine 112 communicates with the integrating engine 114. In an aspect, the integrating engine 114 merges the result of individual and organization searches. The integrating engine 114 communicates with the individual name search engine 116 and the organizational name search engine 118.

In an aspect, the individual name search engine 116 provides the service for access the fuzzy matcher of the individual names.

In an aspect, the organizational name search engine 118 provides the service for access the fuzzy matcher of the organizational names.

The individual name search engine 116 and the organizational name search engine 118 communicates with the storage engine 150. The storage engine 150 stores and access all types of TDMs including but not limited to the individual name TDMs and organizational names TDMs.

In an aspect, the individual name search engine 116 searches every time an individual makes a simple transaction-such as including but not limited to booking a flight, opening a bank account and buying a cinema ticket-their identity is checked and accordingly mapped to any of the sanction lists on the

The system 300 further includes the data processing system 200. The data processing system 200 further includes the model trainer system 210 that communicates with the storage 150 and the parallel model trainer system 230. In an embodiment, the data processing system 200 assists in training the TDMs on watchlist names. The data processing system 200 includes the model trainer system 210. The model trainer system 210 includes multiple matrices individually for including but not limited to ngrams and phonetics-based functions. Multiple matrices are ensembled in the phonetic based functions including but not limited to the New York State Identification and Intelligence System (NYIIS), metaphone and double metaphone. Multiple TDMs are created for matching the input names.

In an aspect, hybrid approach for name matching of individual names is executed via the model trainer system 210. The hybrid approach includes two or more methods for consideration of one factor of the accuracy at a time including but not limited to the method with high recall and fast technique and another with the method with high precision. The text indexing method may be used in high recall and fast technique. The method is including but not limited to the ngram searching and phonetic ngram searching using TDM for high recall and fast searching in millions of list name. In an aspect, pre-computing of some data is done in advance for achieving high speed.

In an aspect, the method for achieving précised, string-matching techniques including but not limited to the levenshtein distance and ngram similarity score. The levenshtein distance and ngram similarity score techniques are string-based approach and are steady in nature.

In an aspect, the search space is reduced after applying the high recall technique. Subsequently, high precision technique may be applied to filter out the specific result. In an aspect, multiple machine learning model is trained and utilized. For example, logistic regression model is used at first. Thereby, xgboost regression is utilized and thereafter, the stacking of model id done.

In an aspect, the machine learning models generate a score for comparison among different training models to find the required optimized score.

In an aspect, the rest controller engine 112 is configured to obtain the input data from the user or the data repository 270.

In an aspect, multiple model classifiers include but not limited to the logistic regression, knelghnours classifier, support vector classifier, nalve bayes classifier, decision tree classifier, random forest classifier, gradient boosting classifier, xgb classifier, extra trees classifier and bagging classifier may be utilized to train the model.

In an aspect, the model trainer system 210 communicates with the parallel model trainer system 230. The parallel model trainer system 230 observes change of names in the database (storage) 150 and triggers the model trainer system 210 to retrain the TDMs if any name change is detected. The parallel model trainer system 230 communicates with the object relational engine 250. The object relational engine 250 is further coupled with the storage 150. In an aspect, the object relational engine 250 maps the class to individual and organizational names in a table to create a watchlist. The object relational engine 250 is further coupled with the data repository 270. The data repository 270 collects and stores databases of individual and organization names.

In an aspect, TDM is trained through multiple training techniques including but not limited to the IDF TDM training technique, binary ngram TDM training technique and phonetics ngram training technique. The IDF TDM training technique trains TDM with IDF on actual name.

In another aspect, the binary ngram tdm training technique trains the TDM with binary flag on each match codes and actual names.

In another aspect, the phonetics ngram TDM training technique trains TDM with binary flag on each match codes and combines the match codes.

The resulted data expecting from the IDF training technique is then dimensionally reduced. In an embodiment, the data that is dimensionally reduced applies the singular value decomposition on each TDM to reduce the 18000 dimensions of sparse matrix to 60 dimensions. In another aspect, the resulted data from the binary ngram TDM technique is then dimensionally reduced. In an embodiment, the data that is dimensionally reduced via binary ngram TDM training applies the singular value decomposition on each TDM to reduce the 18000 dimensions of sparse matrix to 60 dimensions. In another embodiment, the resulted data expecting from the phonetics ngram TDM training is further dimensionally reduced. In an embodiment, the dimensionally reduced data applies the singular value decomposition on each TDM to reduce the 18000 dimensions of sparse matrix to 60 dimensions.

In an aspect, the consolidated data and the respective TDM from multiple techniques are normalized and further integrated and stored in the storage 150.

In another aspect, the storage 150 saves all TDM and dimension reduction objects.

In an aspect, the individual names are searched via multiple techniques. The input name is called by API. In another aspect, the API is REST API for taking input. The data is further pre-processed. In an aspect, multiple search techniques are implemented when the length of the name is greater than 0 including but not limited to the IDF TDM search technique, binary ngram TDM search technique and phonetic ngram search technique. Subsequently, the resulted data is merged. In an embodiment, the higher score is taken when the same name is present in more than one cases resulted by multiple techniques. The method directly shows the result if the length of the name is equals to 0.

In another aspect, the individual name is searched through IDF TDM search technique. The input data is vectorized with the help of trained TDM transformation, thereby the input name is converted to the vector. In an embodiment, the data after vectorization is dimensionally transformed with the help of trained singular value transformation. The resulted data transforms the dimension of the name vector to 60.

In an aspect, the data is further mathematically normalized from the vector to dot product. The TDM data arrives after the dot product is then reduced. The data is further partially sorted resulting the top 10000 names indices. In another embodiment, the search space is reduced via partial sorting.

In an aspect, the top 10000 indices data is filtered from the IDF TDM.

In an aspect, the filtered data is further normalized by taking the dot product between the vector and filtered IDF TDM.

In an aspect, the data is again partially sorted for getting the top 2000 name indices. In another embodiment, the sorting is further done to reduce the search space.

In an aspect, a fuzzy score is calculated for each name and the Qratio and the token sort ratio is done to take the max score. In another embodiment, the result is added to the list when the max score is greater than 75 and the threshold.

In an aspect, the result is further partially sorted to get the top 500 names utilizing previously calculated fuzzy score and the final result is thus obtained.

In another aspect, the individual name is further searched through binary ngram search technique. In an embodiment, the input processed is transmitted for vectorization with the help of trained TDM transformation, thereby the input name is converted to the vector. In an embodiment, the data after vectorization is dimensionally transformed with the help of trained singular value transformation. The resulted data transforms the dimension of the name vector to 60.

In an aspect, the data is further mathematically normalized from the vector to dot product. The TDM data arrives after the dot product is then reduced. The data is further partially sorted resulting the top 30000 names indices. In another embodiment, the search space is reduced via partial sorting.

In an aspect, the top 30000 indices data is filtered from the binary ngram TDM and 10000 indices from the IDF model.

In an embodiment, the filtered data is further normalized by taking the dot product between the vector and filtered IDF TDM.

In an aspect, the filtered data is further normalized by taking the dot product between the vector and filtered binary ngram TDM.

In an aspect, the data is again partially sorted for getting the top 15000 name indices. In another embodiment, the sorting is further done to reduce the search space.

In an aspect, the ngram similarity score is calculated for each name and the resulted name is added to the list when the score is greater than the threshold value.

In an aspect, the resulted name is partially sorted, and the top 500 names is obtained to get the final result.

In another aspect, the individual name is further searched through phonetic ngram search technique. In an embodiment, the input processed name is processed, and match code generation is performed. In an embodiment, the codex of including but not limited to the metaphone, NYSIIS and double metaphone is obtained. The data the further combined through phonetic codes into single feature.

In an aspect, the resulted data is vectorized with the help of the trained phonetic ngram TDM transformation. In another embodiment, the ngram TDM transformation transforms the input name into the vector.

In an aspect, the vectorized data is dimensionally transformed with the help of the trained singular value transformer. In another embodiment, the trained singular value transformer transforms the dimension of the name vector to 60.

In an aspect, the data is filtered to obtain the top 30000 indices from the phonetic ngram TDM and 10000 indices from the IDF TDM model.

In an aspect, the matrix vectorized data is multiplied to normalize the vector. In another aspect, the matrix vector multiplication is done to obtain the row wise dot product between the vector and filtered phonetic ngram TDM.

In an aspect, partial sorting is done to the resulted data to obtain 1500 name indices to reduce search space further on.

In an aspect, the phonetic ngram similarity score is calculated for each phonetic codex that is calculating the weighted score from the ngram similarity score and Qratio.

In an aspect, partial sorting is done to obtain the top 500 name indices to obtain the final top result.

In another aspect, the organizational names are searched via multiple techniques including but not limited to the IDF TDM search technique, binary ngram TDM search technique and the phonetic ngram search technique.

In an aspect, the organizational names are searched via multiple techniques. The input name is called by API. In another embodiment, the API is REST API for taking input. The data is further pre-processed. In an aspect, multiple search techniques are implemented when the length of the name is greater than 0 including but not limited to the IDF TDM search technique, binary ngram TDM search technique and phonetic ngram search technique. Subsequently, the resulted data is merged. In an aspect, the higher score is taken when the same name is present in more than one cases resulted by multiple techniques to obtain top 500 names. The method directly shows the result if the length of the name is equals to 0.

In another aspect, the organizational name is searched through IDF TDM search technique. The input data is vectorized with the help of trained TDM transformation, thereby the input name is converted to the vector. In an embodiment, the data after vectorization is dimensionally transformed with the help of trained singular value transformation. The resulted data transforms the dimension of the name vector to 60.

In an aspect, the data is further mathematically normalized from the vector to dot product. The TDM data arrives after the dot product is then reduced. The data is further partially sorted resulting the top 10000 names indices. In another embodiment, the search space is reduced via partial sorting.

In an aspect, the top 10000 indices data is filtered from the IDF TDM.

In an aspect, the filtered data is further normalized by taking the dot product between the vector and filtered IDF TDM.

In an aspect, the data is again partially sorted for getting the top 2000 name indices. In another aspect, the sorting is further done to reduce the search space.

In an aspect, a fuzzy score is calculated for each name and the Qratio and the token sort ratio is done to take the max score. In another aspect, the result is added to the list when the max score is greater than 75 and the threshold.

In an aspect, the result is further partially sorted to get the top 500 names utilizing previously calculated fuzzy score and the final result is thus obtained.

In an aspect, the partial sorting is done from the resulted data to obtain the top 500 name that is utilizing previously calculated fuzzy score, thereby obtaining the final top result.

In another aspect, the organizational name is further searched through binary ngram search technique. In an aspect, the input processed is transmitted for vectorization with the help of trained TDM transformation, thereby the input name is converted to the vector. In an aspect, the data after vectorization is dimensionally transformed with the help of trained singular value transformation. The resulted data transforms the dimension of the name vector to 60.

In an aspect, the data is further mathematically normalized from the vector to dot product. The TDM data arrives after the dot product is then reduced. The data is further partially sorted resulting the top 10000 names indices. In another embodiment, the search space is reduced via partial sorting.

In an aspect, the top 10000 indices data is filtered from the binary ngram TDM and 10000 indices from the IDF model.

In an aspect, the filtered data is further normalized by taking the dot product between the vector and filtered IDF TDM.

In an aspect, the filtered data is further normalized by taking the dot product between the vector and filtered binary ngram TDM.

In an aspect, the data is further partially sorted for obtaining the top 500 name indices. In another embodiment, the sorting is further done to reduce the search space.

In an aspect, the ngram similarity score is calculated for each name and the resulted name is added to the list when the score is greater than the threshold value.

In an aspect, the resulted name is partially sorted, and the top 500 names is obtained to get the final result.

In another aspect, the organizational name is further searched through phonetic ngram search technique. In an aspect, the input data is standardized using v2 standardization. In an aspect, the input processed name is processed, and match code generation is performed. In an aspect, the codex of including but not limited to the metaphone, NYSIIS and double metaphone is obtained. The data the further combined through phonetic codes into single feature.

In an aspect, the resulted data is vectorized with the help of the trained phonetic ngram TDM transformation. In another aspect, the ngram TDM transformation transforms the input name into the vector.

In an aspect, the vectorized data is dimensionally transformed with the help of the trained singular value transformer. In another aspect, the trained singular value transformer transforms the dimension of the name vector to 60.

In an aspect, the transformed data is mathematically converted to dot product for normalizing the vector.

In an aspect, the data is filtered to obtain the top 30000 indices from the phonetic ngram TDM and 10000 indices from the IDF TDM model.

In an aspect, the matrix vectorized data is multiplied to normalize the vector. In another aspect, the matrix vector multiplication is done to obtain the row wise dot product between the vector and filtered phonetic ngram TDM.

In an aspect, partial sorting is done to the resulted data to obtain 1500 name indices to reduce search space further on.

In an aspect, the phonetic ngram similarity score is calculated for each phonetic codex that is calculating the weighted score from the ngram similarity score and Qratio. In an aspect, the average of all phonetic score is obtained. In an embodiment, the resulted data is added to the list when the score is greater than 70 and threshold value.

In an aspect, partial sorting is done to obtain the top 500 name indices to obtain the final top result.

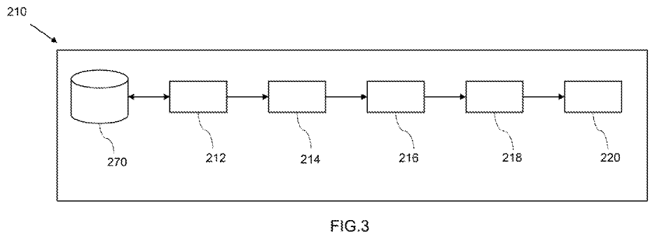

Referring to FIG. 3, a block diagram of a system 210 for training a model, in accordance with an exemplary aspect of the present disclosure.

The system 210 includes the data repository 270, a data read engine 212, the pre-processing engine 214, a match code generation engine 216, a TDM trainer engine 218 and a TDM storage 220.

The system 210 for training a model includes the data repository 270 that communicates with the data read engine 212. The data read engine 212 communicates with the pre-processing engine 214. The pre-processing engine 214 communicates with the match code generation engine 216. The match code generation engine 216 communicates with the TDM trainer engine 218. The TDM trainer engine 218 communicates with the TDM storage 220.

The system 210 includes the data repository 270. In an embodiment, the data repository 270 includes individual and organization names. The data repository 270 communicates with the data read engine 212. The data read engine 212 reads all the names of individual and organization from the data repository 270. The data read engine 212 communicates with the pre-processing engine 214. The pre-processing engine 214 processes the name with respect to the category of name. The pre-processing engine 214 standardizes the name when the name is the organizational name. In an aspect, the pre-processing engine 214 removes the title and honorifics. In another aspect, the pre-processing engine 214 removes character that is other than alphabet. In another aspect, the pre-processing engine 214 removes all the stopwords from the name. In another aspect, the pre-processing engine 214 dedupes the list of names and keeps the primary key of all different names. The pre-processing engine 214 communicates with the match code generation engine 216. The match code generation engine 216 collects the codex including but not limited to the metaphone, NYSIIS and double metaphone for each name. The match code generation engine 216 communicates with the TDM trainer engine 218. The TDM trainer engine 218 trains TDM with the intermediate distribution frame (IDF) on the real name. In an embodiment, the TDM trainer engine 218 trains TDM with the binary flag on ngram (1-3) of each match codes and real names. In another aspect, the TDM trainer engine 218 applies the singular value the decomposition on each TDM to reduce the 18000 dimensions of sparse matrix to 60 dimensions. In another embodiment, the TDM trainer engine 218 normalizes all the TDMs.

The TDM trainer engine 218 communicates with the TDM storage 220. The TDM storage 220 collects, stores, and saves all the TDM acquired by the system 210.

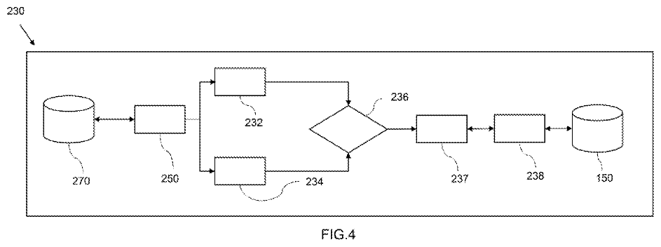

Referring to FIG. 4, a block diagram of a system 230 of parallel model trainer, in accordance with an exemplary aspect of the present disclosure.

The system 230 includes the data repository 270, the object relational engine 250, an organization name listener engine 232, an individual name listener engine 234, an analyzation engine 236, an ensemble meta-learner model engine 237, a memory 238 and the storage 150.

The system 230 includes the data repository 270 that communicates with the object relational engine 250. The object relational engine 250 communicates with the organization name listener engine 232 and the individual name listener engine 234. The organization name listener engine 232 and the individual name listener engine 234 communicates with the analyzation engine 236. The analyzation engine 236 communicates with the ensemble meta-learner model engine 237. The ensemble meta-learner model engine 237 communicates with the memory 238. The memory 238 communicates with the storage 150.

The system 230 includes the data repository 270 that communicates with the object relational engine 250. In an embodiment, the object relational engine 250 maps the class to individual and organizational names table. The object relational engine 250 communicates with the organization name listener engine 232 and the individual name listener engine 234. The organization name listener engine 232 updates and extracts the name where pytn_update_flg_field in watchlist is true. The individual name listener engine 234 extracts and updates the name where pytn_update_flg_field in watchlist is true. The organization name listener engine 232 and the individual name listener engine 234 communicates with the analyzation engine 236. The analyzation engine 236 analyses the names and transmit the data to the memory 238 via the ensemble meta-learner model engine 237 for storing purpose. In an aspect, the analyzation engine 238 processes the data. The memory 238 stores the names when the ensemble meta-learner model engine 237 performs machine learning models to provide highest probability of the precise output data. Furthermore, the analyzation engine 236 validates the name. In an embodiment, the collected data is then trained by the model trainer system 210. Subsequently, the trained data is further stored in the storage 150. In an embodiment, the updated data TDMs is updated and stored in the storage 150.

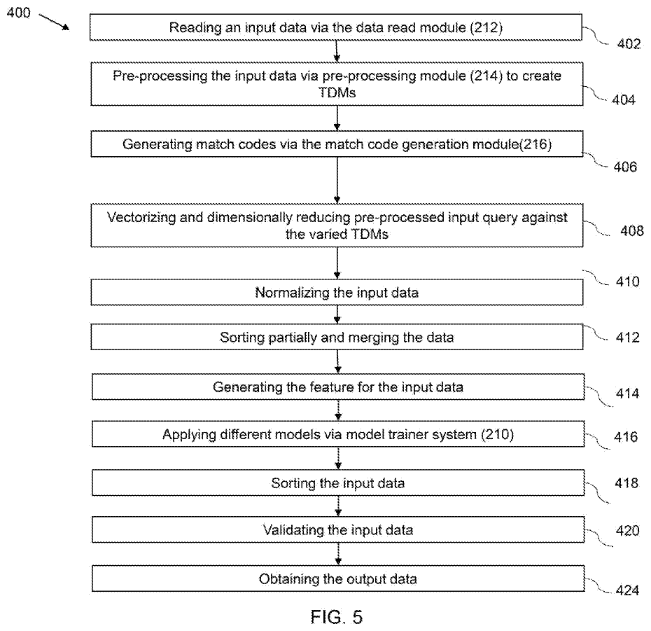

Referring to FIG. 5, a flowchart of a method 400 that depicts working of the system 100 of FIG. 1, in accordance with an exemplary aspect of the present disclosure.

At step 402, the input data is read by the data read engine 212.

At step 404, the input data is pre-processed by the pre-processing engine 214 to create TDMs.

At step 406, match codes are generated by the match code generation engine 216.

At step 408, the pre-processed input query is vectorized and dimensionally reduced against the varied TDMs.

At step 410, the input data is normalized.

At step 412, the input data is sorted partially and merged by the integrating engine 114.

At step 414, the features are generated for the input data.

At step 416, multiple models are applied via the model trainer system 210.

At step 418, the input data is then sorted.

At step 420, the input data is validated.

At step 422, the input data is obtained and stored in the data repository 270.

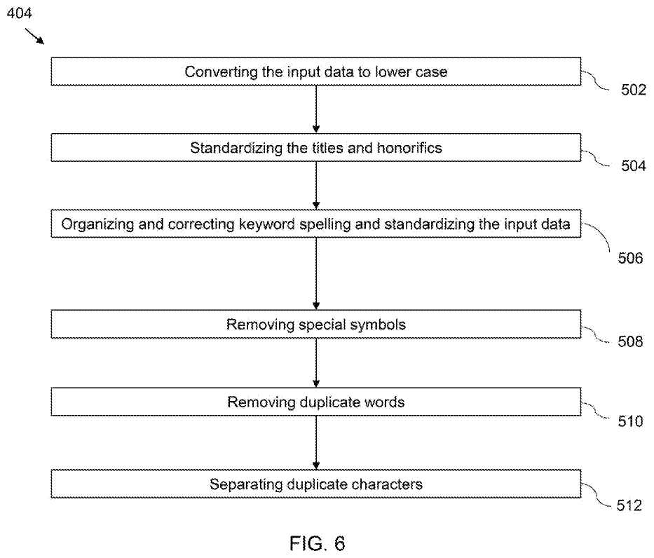

Referring to FIG. 6, a flowchart of a method 404 that depicts working of pre-processing an input data of FIG. 5, in accordance with an exemplary aspect of the present disclosure.

At step 502, the input data is converted to lower case.

At step 504, the titles and honorifics are standardized.

At step 506, the keyword spellings are organized, corrected, and standardized.

At step 508, special symbols are removed.

At step 510, duplicate words are removed.

At step 512, duplicate characters are separated.

As will be readily apparent to those skilled in the art, the present embodiment may easily be produced in other specific forms without departing from its essential characteristics. The present embodiment are, therefore, to be considered as merely illustrative and not restrictive, the scope being indicated by the claims rather than the foregoing description, and all changes which come within therefore intended to be embraced therein.

We claim:

1. A hybrid ensemble-based system (300) for screening and matching names, the system (300) comprises:
a search engine system (110) configured with a storage engine (150) for searching individual and organizational names from a data repository (270), wherein the search engine system (110) characterized in that an individual name search engine (116) and an organizational name search engine (118); and
a data processing system (200) coupled with the search engine system (110) via the storage (150) for training the models.

2. The system (300) as claimed in claim 1, wherein the search engine system (110) comprises a rest controller engine (112) that communicates with an integrating engine (114) that is configured to obtain an input data from the user or the data repository (270).

3. The system (300) as claimed in claim 1, wherein the integrating engine (114) is configured with the individual name search engine (116) and the organizational name search engine (118) to merge the result generated from the individual name search engine (116) and the organizational name search engine (118).

4. The system (300) as claimed in claim 1, wherein the individual name search engine (116) and the organizational name search engine (118) communicates with the storage (150) for accessing the fuzzy matcher of individual names and fuzzy matcher of organizational names respectively.

5. The system (300) as claimed in claim 1, wherein the data processing system (200) includes a model trainer system (210) that communicates with a parallel model trainer system (230) for executing the name matching of individual names and organizational names via hybrid approach.

6. The system (300) as claimed in claim 1, wherein the parallel model trainer system (230) communicates with an object relational engine (250) and the data repository (270) for mapping the classes to individual and organizational names in a table to create a watchlist.

7. The system (300) as claimed in claim 1, wherein the object relational engine (250) communicates with the data repository (270), wherein the data repository (270) further collects and stores the databases of individual and organization names.

8. A system (210) for training the model to observe amendments on names in the data repository (270), the system (210) comprises:
a data read engine (212) coupled with the data repository (270) to read the names of individual and organization from the data repository (270);
a pre-processing engine (214) coupled with the data read engine (212) to process the names with respect to the category of names;
a match code generation engine (216) coupled with the pre-processing engine (214) to collect the codex;
a TDM trainer engine (218) coupled with the match code generation engine (216) to train the TDM with the intermediate distribution frame (IDF) on the actual name; and
a TDM storage (220) coupled with the TDM trainer engine (218) to save and collect the TDM data acquired by the model trainer system (210).

9. The system (210) as claimed in claim 8, wherein the TDM trainer engine (218) applies the singular value the decomposition on each TDM to reduce the dimensions of an input data.

10. A system (230) of parallel model trainer to observe amendments on names in the data repository (270), the system (230) comprises:
an organizational name listener engine (232) coupled with the object relational engine (250) and the data repository (270) to update organizational name TDMs;
an individual name listener engine (234) coupled with the object relational engine (250) and the data repository (270) to update the individual name TDMs;
an analyzation engine (236) coupled with the organizational name listener engine (232) and the individual name listener engine (234) to validate and process the individual and organizational names; and
a memory (238) coupled with the analyzation engine (236), wherein the memory (238) stores the names when the analyzation engine (236) validates the name.

11. The system (230) as claimed in claim 10, wherein the memory (238) is further coupled with the storage (150) to store TDMs.

12. An ensemble meta-learner model system (100), the system (100) comprises:
an input engine (310) for receiving an input data that includes individual and organizational names;
a pre-processing engine (214) configured with the input engine (310) to standardize the input data;
a high recall-high search filter (320) configured with the pre-processing engine (214) to perform a search analysis on the input data;
a feature generation engine (330) configured with the high recall-high search filter (320) to transform and prepare the input data for training;
a first model engine (340-1) configured with the feature generation engine (330) to provide first probability of matched names from the input data;
a second model engine (340-2) configured with the feature generation engine (330) to provide second probability of matched names from the input data; and
an ensemble meta-learner model engine (350) coupled the first model (340-1) and the second model (340-2) to provide final probability of matched names from the input data.

13. The system (100) as claimed in claim 12, wherein the high recall-high search filter (320) provides top 500 names from the input data.

14. The system (100) as claimed in claim 12, wherein the feature generation engine (330) generates the feature on the input data and passed through the trained model by the first model engine (340-1), the first model engine (340-2) and the ensemble meta-learner model engine (350) for scoring.

15. The system (100) as claimed in claim 12, wherein the final probability of matched names from the input data is stored in the output engine (360).

16. The method (400) for screening and matching names, the method comprises:
reading (402) an input data via the data read engine (212);
pre-processing (404) the input data via pre-processing engine (214) to create term document matrix (TDM);
generating (406) match codes via the match code generation engine (216);
vectorizing and dimensionally reducing (408) pre-processed input query against the varied TDMs;
normalizing (410) the input data;
sorting partially (412) and merging the input data;
generating (414) the feature for the input data;
applying (416) different models via model trainer system (210);
sorting (418) the input data;
validating (420) the input data; and
obtaining (422) an output data.

17. The method (500) for pre-processing an input data via pre-processing engine (214) to create term document matrix (TDM), the method comprises:
converting (502) the input data to lower case;
standardizing (504) the titles and honorifics;
organizing and correcting (506) keyword spelling and standardizing the input data;
removing (508) special symbols;
removing (510) duplicate words; and
separating (512) duplicate characters.
